(19) United States
(12) Patent Application Publication
(10) Pub. No.: US 2019/0313859 A1
(43) Pub. Date: Oct. 17, 2019

(54) DOUBLE SERRATED FORK

(71) Applicant: Dashamir Elezi, Tirana (AL)

(72) Inventor: Dashamir Elezi, Tirana (AL)

(21) Appl. No.: 16/248,872

(22) Filed: Jan. 16, 2019

Related U.S. Application Data
(62) Division of application No. 14/240,906, filed on Feb. 25, 2014, now abandoned.

(30) Foreign Application Priority Data
Aug. 25, 2011 (AL) ALP20113817

(51) Int. Cl. A47J 43/28; A47G 21/02

(52) U.S. Cl. CPC A47J 43/283; A47G 21/023

(57) ABSTRACT

A hand-held ergonomic utensil for securely holding and maneuvering food during preparation, peeling and/or cutting is disclosed. The utensil includes four long ratchet tines, positioned two by two in different parallel planes, made of stainless steel material that is safe for penetrating food. The utensil includes a body portion that joins proximal ends of the tines together and two small tines each small tine being positioned in a common plane of a respective pair of long ratchet tines substantially centrally therebetween and projecting from the body portion. The utensil includes a shaft that extends from the center of the body portion in a proximal direction and a handle that is attached at a proximal end of the shaft, and has a surface made of frictional material.

### CROSS REFERENCE TO RELATED APPLICATIONS

This application is a divisional application of U.S. application Ser. No. 14/240,906, filed Feb. 25, 2014 which is a national phase of PCT application No. PCT/AL2012/000001, filed Jun. 29, 2012, which claims priority to AL patent application No. AL/P/2011/3817, filed Aug. 25, 2011, all of which are incorporated herein by reference thereto.

### TECHNICAL FIELD

The title of the invention is “SG MAITREFORK”; the initials as defined by the inventor, while the word “MAITREFORK” contains in itself the purpose of this invention, which consists of a hand-held ergonomic utensil with four long ratchet tines, positioned 2 by 2 in two different parallel planes, which is used in the food and restaurant industry and specifically in modem restaurants (kitchens) in which Maitre (Chief Hall) performs completion of cooking and preparation in the presence or in front of the client in the restaurant. Also, this invention finds its use in different restaurants related to fast food (fast food, take-out etc.).

### BACKGROUND ART

Before this invention there was not any similar hand-held utensil for securely handling food, through which the products could be processed without any supporting plane or plates, but instead, with the use of S G Maitrefork” utensil everything is accomplished while the product is anchored through the utensil, the product is not supported into a working plane or plate, with a very good stability and easily maneuvering of the tool by a user. Before, prior carving utensils required supporting the food item on a table and using a carving fork or pliers as a blocker (holding) element for the food item.

### BRIEF DESCRIPTION OF THE DRAWINGS

The invention will be described in further detail below and with reference to the attached drawings in which:

FIGS. 1A and 1B are a top view and side view, respectively, of a ratchet tine with arch shaped profile of radius R=6 mm, with the length of the extending element (not pulled back/un-folded) is 96 mm, 19 mm width, 1.5 mm thickness, and Φ4 mm diameter central hole, which serves to connect with the body portion;

FIGS. 2A and 2B are a top view and side view, respectively, of a ratchet tine with arch shaped profile of radius R=9 mm, with the length of the extended element (not pulled back/un folded) is 106 mm, 21 mm width, 1.5 mm thickness, and Φ4 mm diameter central hole, which serves to connect with the body portion;

FIGS. 3A and 3B are a top view and side view, respectively, of a ratchet tine with arch shaped profile of radius R=10 mm and 6 mm length, with the length of the extended element (not pulled back/un folded) is 146 mm, 40.31 mm width, 2 mm thickness, and Φ4 mm diameter central hole, which serves to connect with the body portion, with the length of the central tine is 10 mm with 4 mm inner radius;

FIGS. 4A and 4B are a top view and side view, respectively, of a ratchet tine with arch shaped profile of radius R=14.5 mm and 10 mm length, with the length of the extended element (not pulled back/un folded) is 146 mm, 40.31 mm width, 2 mm thickness, and Φ4 mm diameter central hole, which serves to connect with the body portion, with the length of the central tine is 10 mm with 4 mm inner radius;

FIGS. 5A and 5B are a top view and side view, respectively, of a ratchet tine with arch shaped profile of radius R=9.28 mm and 6 mm length, with the length of the extended element (not pulled back/un folded) is 146 mm, 48.83 mm width, 2 mm thickness, and Φ4 mm diameter central hole, which serves to connect with the body portion, with the length of the central tine is 10 mm with 7 mm inner radius;

FIGS. 6A and 6B are a top view and side view, respectively, of a ratchet tine with arch shaped profile of radius R=14.5 mm and 10 mm length, with the length of the extended element (not pulled back/un folded) is 146 mm, 48.83 mm width, 2 mm thickness, and Φ4 mm diameter central hole, which serves to connect with the body portion, with the length of the central tine is 10 mm with 7 mm inner radius;

FIG. 7 is a perspective view of an embodiment of the invention;

FIG. 8 is a perspective view of an alternative embodiment of the invention with an additional smaller tine positioned in between two ratchet lines.

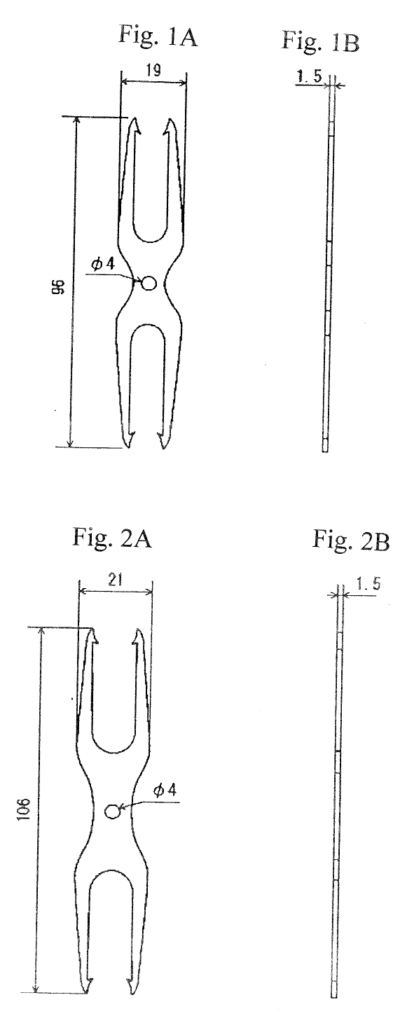

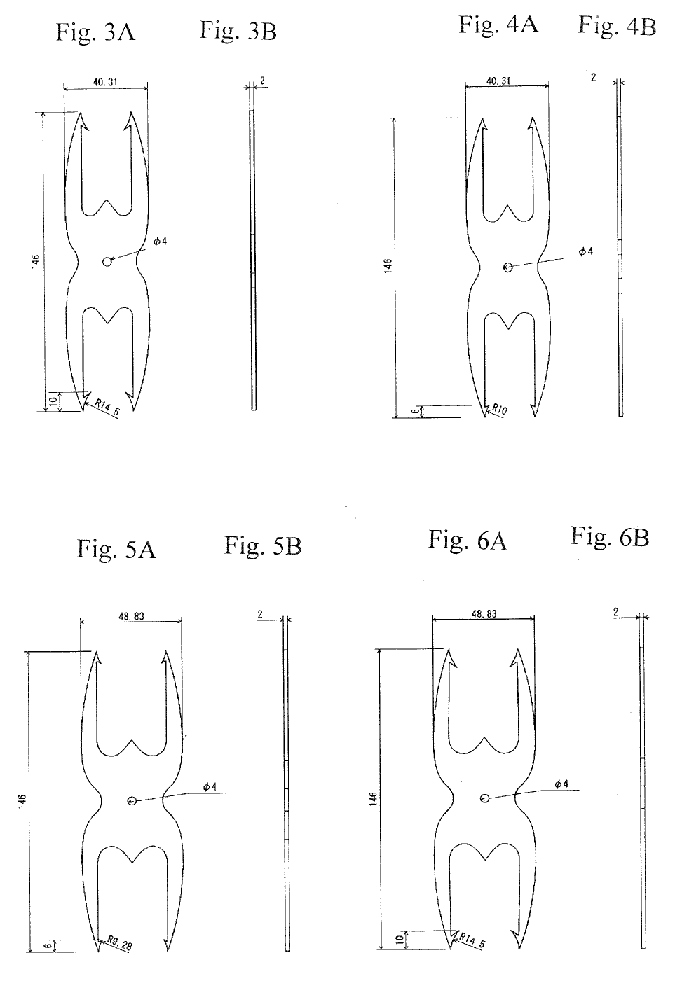

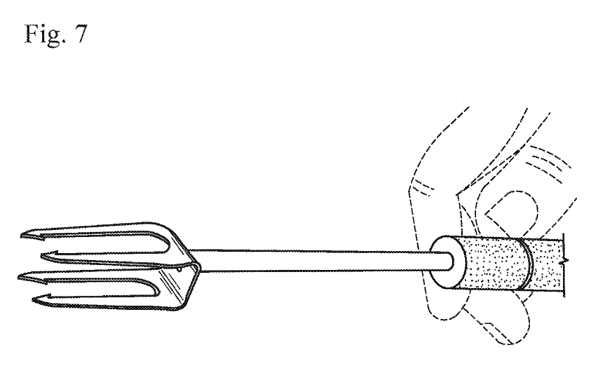

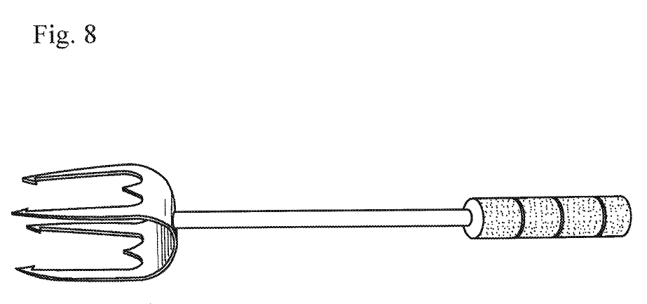

### DESCRIPTION

The invention includes a hand-held ergonomic utensil with four long ratchet tines, positioned 2 by 2 in two different parallel planes; the projection of an upper view of the device, shows the teeth placed in the corners of a rectangle; it is used in the food and restaurant industry and specifically in the modern restaurants in which Maitre (the Chief Hall) performs completion of a cooking and/or entire preparation of a plate/dish in the presence or in front of the client present in the restaurant. Also, this invention finds use in different types of restaurants related to fast food (fast food, take out).

The stability of the food item, which will be handled and processed (i.e., removal of the skin or product fragmentation) by a user is obtained with this type of tool as the four tines of the utensil, as it can be seen from the respective drawings, are placed in a position that represents the four corners of the square (when viewed from a distal end), and are equipped with ratchet (blocker tines) which holds firmly the food product to be handled, while maintaining its stability by the user.

In accordance with the invention, this utensil comes in different sizes for use in different situations with different food products. In this way it becomes possible not to damage the product during the cutting, cutting in a correct way, therefore efficiently preparing and handling the food, while performing the food service in front of the client. The prior utensils used before have some disadvantages which are: non-proper stability, lack of accurate maneuverability with the food product, the lack of precision in cutting the food product, all of which lead to a situation that is not economically efficient.

What is claimed is:

1. A hand-held ergonomic utensil for securely holding and maneuvering food during preparation, peeling, and/or cutting by a user, comprising:
four long ratchet tines forming two pairs positioned in two parallel planes, each long ratchet tine having a proximal end and a distal end;
a body portion that joins the proximal ends of the four long ratchet tines and extends, at least partially, substantially transverse to a longitudinal extent of the four long ratchet tines;
two small tines, each small tine being positioned in the common plane of a respective pair of the long ratchet tines substantially centrally therebetween and projecting from the center of the body portion that joins the proximal ends of the long ratchet tines for providing additional food support and stability;
a shaft extending from a center of the body portion in a proximal direction; and
a handle attached to a proximal end of the shaft.

2. An ergonomic utensil of claim 1,
wherein a distal end of each long ratchet tine has a laterally projecting barbed formation for secure holding the food, and
wherein each ratchet tine is shaped in an extended linear form within a common plane forming one of the two parallel planes along an entire length of the long ratchet tine from the proximal end thereof to the distal end thereof.

3. The ergonomical utensil of claim 1, wherein a collective length of the shaft and the handle exceeds at least twice the entire length of the long ratchet tines for providing a better maneuverability.

4. The ergonomic utensil of claim 1, wherein the handle has a circular profile with a diameter ranging from 23 mm to 25 mm.

5. The ergonomic utensil of claim 3, wherein the handle is weighted to provide stability to the utensil during use, and wherein the handle has ridges thereon for creating effective gripping conditions for the user's hand.

6. The ergonomic utensil of claim 1, wherein the long ratchet tines are made of stainless steel, the handle is made of porous wooden or plastic material.

7. An ergonomic utensil of claim 1, wherein a length of each small tine is several times smaller than the entire length of the long ratchet tine.

8. An ergonomic utensil of claim 7, wherein the length of each small tine is at least four times smaller than the entire length of the long ratchet tine.
